(19) United States
(12) Patent Application Publication
(10) Pub. No.: US 2014/0166615 A1
(43) Pub. Date: Jun. 19, 2014

(54) MOLD STRUCTURE AND METHOD OF IMPRINT LITHOGRAPHY USING THE SAME

(71) Applicant: Electronics and Telecommunications Research Institute, Daejeon (KR)

(72) Inventors: Zin Sig KIM, Daejeon (KR); Hokyun Ahn, Daejeon (KR)

(21) Appl. No.: 13/939,530

(22) Filed: Jul. 11, 2013

(30) Foreign Application Priority Data
Dec. 13, 2012 (KR) 10-2012-0145552

(51) Int. Cl. B29C 59/02

(52) U.S. Cl. CPC B29C 59/022
USPC 216/42; 425/385; 264/496

(57) ABSTRACT

Mold structures for imprint lithography are provided. Mold chip patterns including patterns for nano structures are disposed on a mold substrate. A trench region is provided between the mold chip patterns. Protrusion portions protrude from a bottom surface of the trench region. The protrusion portions extend along the trench region in a plan view.

### CROSS-REFERENCE TO RELATED APPLICATIONS

This U.S. non-provisional patent application claims priority under 35 U.S.C. §119 to Korean Patent Application No. 10-2012-0145552, filed on Dec. 13, 2012, the entirety of which is incorporated by reference herein.

### BACKGROUND

The inventive concept relates to a mold structure for imprint lithography and, more particularly, to a mold structure having a trench structure for exhausting a resist and a method of imprint lithography using the same.

Future integrated circuits need reliable patterning techniques for forming nanometer sized devices. A photo lithography process is generally used for the patterning techniques. However, the photo lithography process has a limit of resolution since the interference of light occurs at patterns having widths less than a predetermined width. Thus, various researches have been conducted for new lithography processes substituting for the photo lithography process from the mid-90s. For example, an electron-beam lithography process, an X-ray lithography process, and a scanning probe lithography process have been developed. However, the new lithography processes may have limits in process efficiency and costs.

In a nano imprint lithography process, a stamp in which a nano structure is carved may be imprinted on a resist coated on a substrate, such that the nano structure may be transferred to the resist. Thus, the nano structure may be repeatedly manufactured. In other words, the nano imprint lithography process is a technique capable of economically and effectively manufacturing the nano structure. The nano imprint lithography process may need a material technique, a mold manufacture technique, an adhesion preventing layer technique, and an etching technique in which physical phenomena of nano-scale structures are reflected. The nano imprint lithography process may be applied to a ultrahigh speed nano-scale metal-oxide-silicon field effect transistor (MOSFET), a high density magnetic device, and a high density compact disk.

According to the first nano imprint lithography process developed by professor Chou et al. in 1996, a mold may be imprinted on a resist of polymethylmethacrylate (PMMA) coated on a substrate at a high temperature, and then they may be cooled. Thereafter, the mold may be separated from the resist. Thus, an opposite shape of the nano structure carved in the mold may be imprinted on the resist, and then a residual resist may be completely removed by an anisotropic etching process. If the imprint lithography process uses an ultraviolet-curable material, the imprint lithography process may be performed at a relatively low temperature by a relatively low pressure.

### SUMMARY

Embodiments of the inventive concept may provide a mold structure capable of smoothly exhausting a residual resist in imprint lithography.

Embodiments of the inventive concept may also provide a method of imprint lithography using a mold structure capable of smoothly exhausting a residual resist.

In one aspect, a mold structure for imprint lithography may include: mold chip patterns provided on a mold substrate, the mold chip patterns including patterns for forming nano structures; a trench region disposed between the mold chip patterns; and protrusion portions protruding from a bottom surface of the trench region, the protrusion portions extending along the trench region.

In an embodiment, the mold chip patterns may be arranged in a first direction and a second direction crossing the first direction on the mold substrate; and the trench region may have a grid-shape extending in the first direction and the second direction.

In an embodiment, the mold chip patterns may be arranged in a first direction and a second direction crossing the first direction on the mold substrate; and the trench region may include a plurality of linear type trenches extending in the first direction.

In an embodiment, a height of a top surface of each of the protrusion portions may be lower than a height of a topmost surface of the mold chip patterns.

In an embodiment, the height of the top surface of each of the protrusion portions may be substantially equal to or less than a half of the height of the topmost surface of the mold chip patterns.

In an embodiment, the height of the top surface of the each of the protrusion portions may be within a range of about 60% to about 90% of the height of the topmost surface of the mold chip patterns.

In an embodiment, the heights of the top surfaces of the protrusion portions may be reduced as a distance from the mold chip pattern increases.

In an embodiment, a sidewall of the trench region may have a rounded surface.

In an embodiment, the mold substrate may include quartz, glass, or sapphire.

In an embodiment, a width of the trench region may be less than a width of each of the mold chip patterns.

In an embodiment, a method of imprint lithography may include: coating a resist on a base substrate; pressing the resist with a mold structure; hardening the resist; and separating the mold structure from the base substrate. The mold structure may include: mold chip patterns provided on a mold substrate, the mold chip patterns including patterns for forming nano structures; a trench region disposed between the mold chip patterns; and protrusion portions protruding from a bottom surface of the trench region, the protrusion portions extending along the trench region.

In an embodiment, hardening the resist may include: irradiating an ultraviolet ray to the resist.

In an embodiment, the resist may be coated by a spin coating method, a droplet dispensing method, or a spraying method.

In an embodiment, the mold chip patterns may be arranged in a first direction and a second direction crossing the first direction on the mold substrate; and the trench region may have a grid-shape extending in the first direction and the second direction.

In an embodiment, the mold chip patterns may be arranged in a first direction and a second direction crossing the first direction on the mold substrate; and the trench region may include a plurality of linear type trenches extending in the first direction.

In an embodiment, a height of a top surface of each of the protrusion portions may be lower than a height of a topmost surface of the mold chip patterns.

In an embodiment, the method may further include: etching the base substrate using the hardened resist as an etch-mask.

In an embodiment, the method may further include: dividing the etched base substrate along a dicing line.

In an embodiment, the trench region may have a shape corresponding to the dicing line.

### BRIEF DESCRIPTION OF THE DRAWINGS

The inventive concept will become more apparent in view of the attached drawings and accompanying detailed description.

FIG. 1 is a plan view illustrating a mold structure for imprint lithography according to an embodiment of the inventive concept;

FIG. 2 is a cross-sectional view taken along a line I-I′ of FIG. 1;

FIGS. 3A to 3D are cross-sectional views illustrating examples of a trench region and protrusion portions according to embodiments of the inventive concept;

FIG. 4 is a plan view illustrating a mold structure for imprint lithography according to another embodiment of the inventive concept;

FIGS. 5A and 5B are cross-sectional views taken along lines A-A′ and B-B′ of FIG. 4, respectively;

FIG. 6 is a flowchart illustrating a method of imprint lithography using a mold structure according to embodiments of the inventive concept; and

FIG. 7 is a cross-sectional view illustrating a method of imprint lithography using a mold structure according to embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

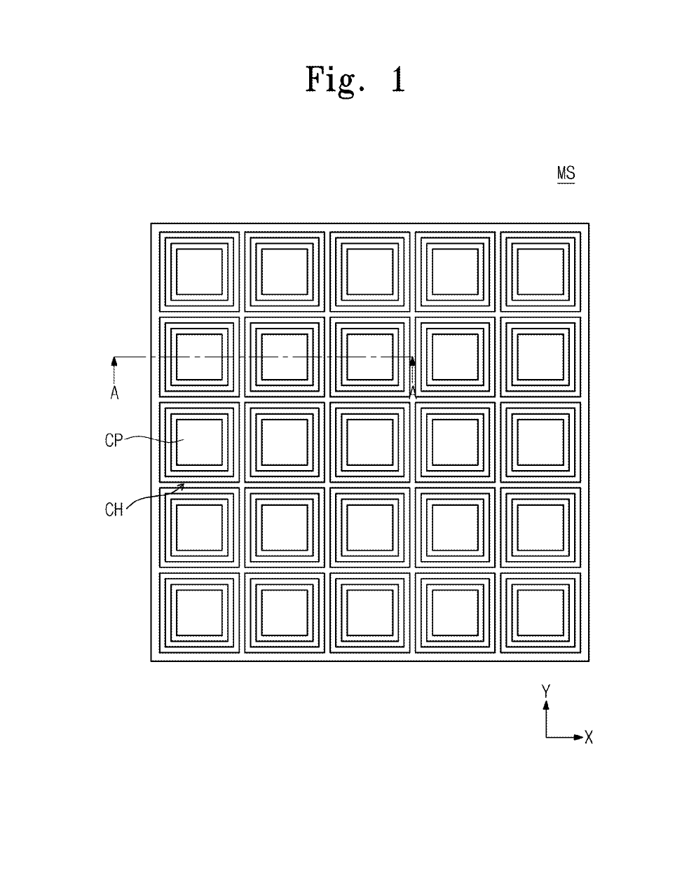

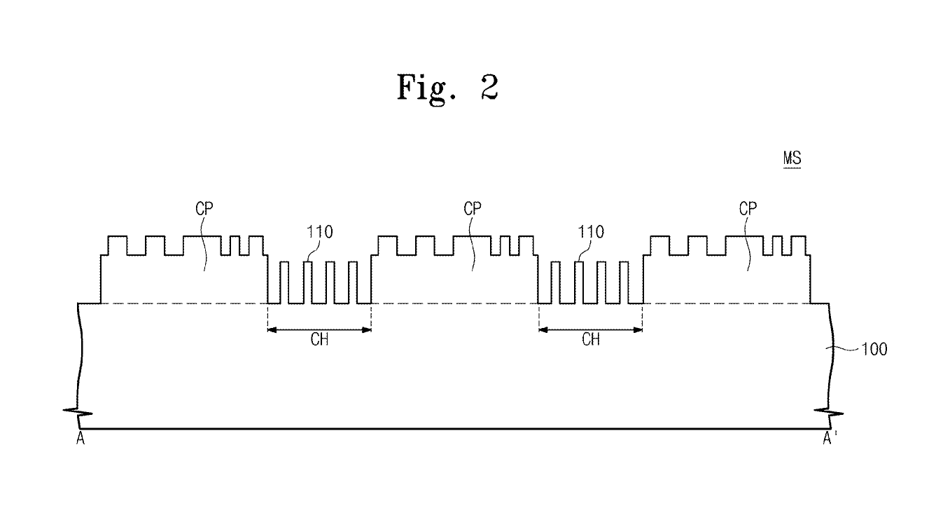

FIG. 1 is a plan view illustrating a mold structure for imprint lithography according to an embodiment of the inventive concept. FIG. 2 is a cross-sectional view taken along a line I-I′ of FIG. 1.

Referring to FIGS. 1 and 2, a mold structure MS for imprint lithography will be described hereinafter. The mold structure MS may include a mold substrate 100 and mold chip patterns CP protruding from the mold substrate 100. The mold structure MS may include a transparent material such as quartz, glass, or sapphire. Alternatively, the mold structure 100 may include an opaque material such as a metal.

The mold chip patterns CP may be patterns for forming nano structures in a resist. Each of the mold chip patterns CP may have a concavo-convex part corresponding to a desired nano structure. The concavo-convex part may be formed in an upper portion of the mold chip pattern CP. The mold chip patterns CP may be two-dimensionally arranged on the mold substrate 100. In other words, the mold chip patterns CP may be arranged along a first direction and a second direction (hereinafter, referred to as ‘a y-direction) crossing the first direction (hereinafter, referred to as ‘an x-direction).

A trench region CH may be provided between the mold chip patterns CP. The trench region CH may be a recessed region between the mold chip patterns CP. A width of the trench region CH in the x-direction may be less than a width of the mold chip pattern CP. The trench region CH may have a grid-shape extending in the x-direction and the y-direction.

Protrusion portions 110 may be provided in the trench region CH. The protrusion portions 110 may protrude from a top surface of the mold substrate 100 (i.e., a bottom surface of the trench region CH). The protrusion portions 110 may extend in an extending direction of the trench region CH in a plan view. For example, if the trench region CH has the grid-shape, the protrusion portions 110 may have a grid-shape in a plan view.

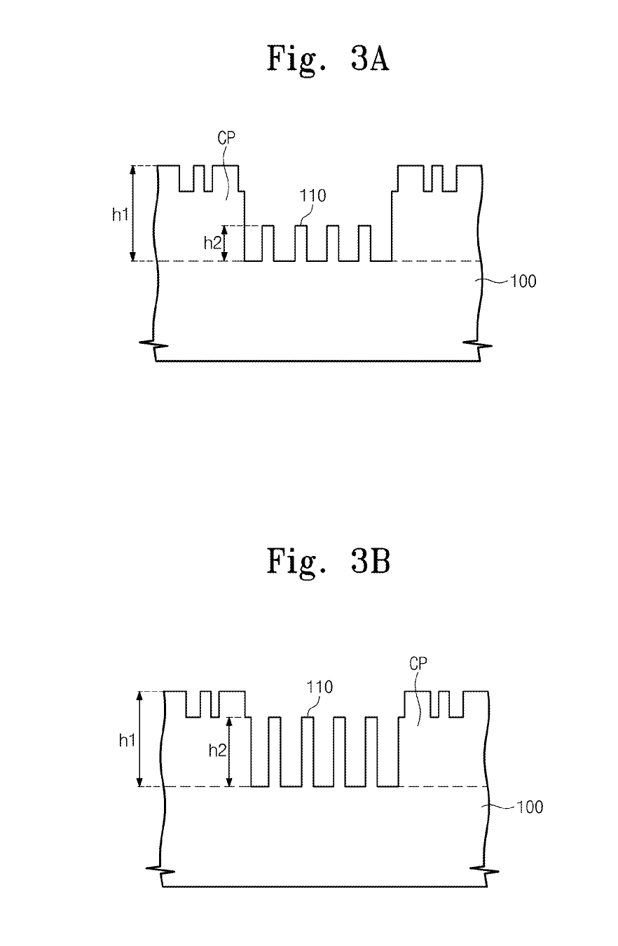

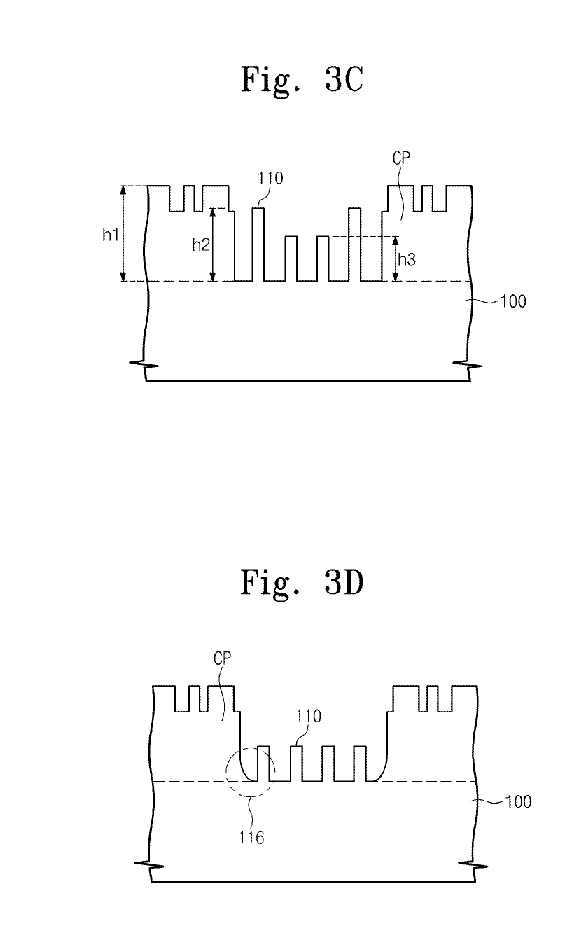

FIGS. 3A to 3D are cross-sectional views illustrating examples of a trench region and protrusion portions according to embodiments of the inventive concept.

As illustrated in FIG. 3A, a height h2 of a top surface of each of the protrusion portions 110 may be lower than a height h1 of a topmost surface of the mold chip patterns CP from the top surface of the mold substrate 100. In an embodiment, the height h2 of the protrusion 110 may be substantially equal to or less than a half of the height h1 of the mold chip pattern CP. In another embodiment, as illustrated in FIG. 3B, the height h2 of the protrusion 110 may be within a range of about 60% to about 90% of the height h1 of the mold chip pattern CP.

The protrusion portions 110 may include protrusion portions of which heights are different from each other. In an embodiment, as illustrated in FIG. 3C, the heights of the protrusion portions 110 may be reduced as a distance from the mold chip pattern CP increases. In other words, the heights of the protrusion portions 110 may be reduced from the heights h2 to a height h3 as a distance from the mold chip pattern CP increases.

In FIGS. 3A, 3B, and 3C, a boundary between the trench region CH and the mold chip pattern CP (i.e., a sidewall of the trench region CH) is perpendicular to the top surface of the mold substrate 100. Alternatively, the sidewall of the trench region CH may be inclined. In an embodiment, the sidewall of the trench region CH may have a rounded shape 116, as illustrated in FIG. 3D.

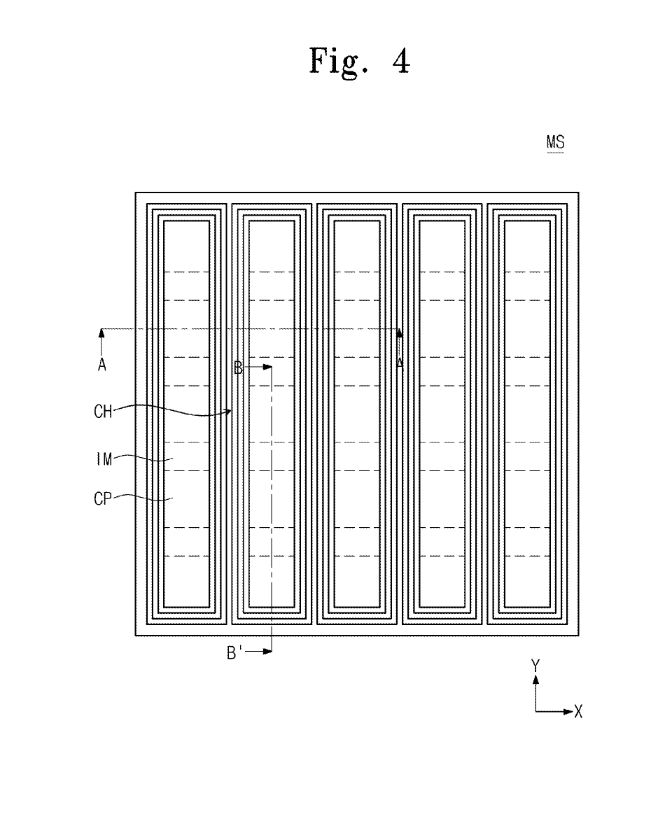

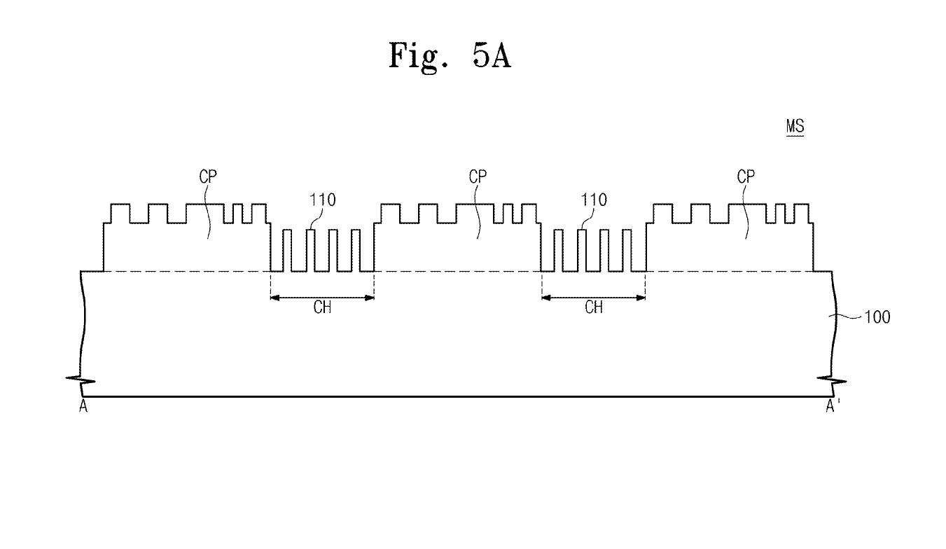

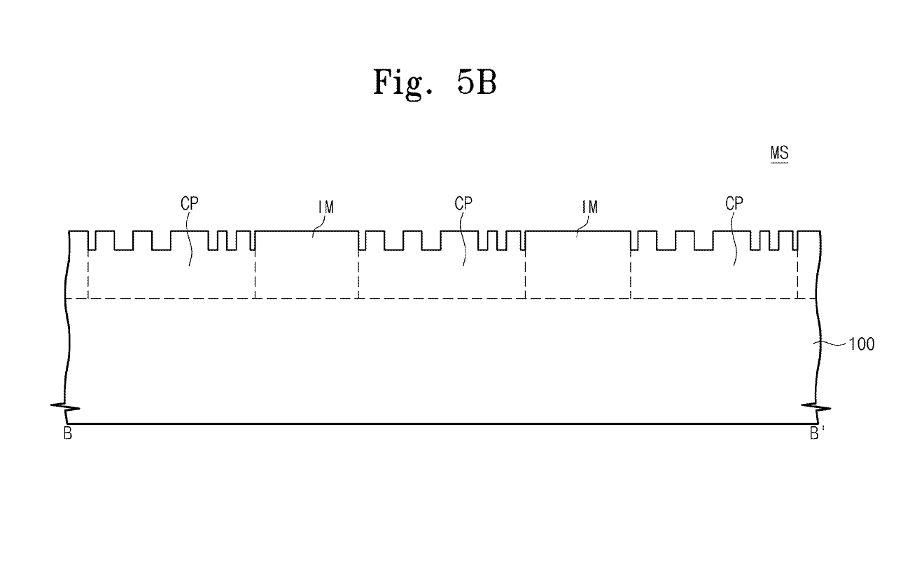

FIG. 4 is a plan view illustrating a mold structure for imprint lithography according to another embodiment of the inventive concept. FIGS. 5A and 5B are cross-sectional views taken along lines A-A′ and B-B′ of FIG. 4, respectively. In the present embodiment, the descriptions to the same elements as described in the aforementioned embodiment will be omitted or mentioned briefly for the purpose of the ease and convenience in explanation.

In the present embodiment, a trench region CH between mold chip patterns CP may have a linear shape that extends in the y-direction but does not extend in the x-direction. In an embodiment, as illustrated in FIG. 4, the trench region CH may have a plurality of linear type trenches extending in parallel to each other along the y-direction. Protrusion portions 110 in the trench region CH may have linear shapes extending in the y direction corresponding to an extending direction of the trench region CH in a plan view. In other embodiments, a portion of the protrusion 110 having the linear shape may be cut. A boundary part IM may be disposed between the mold chip patterns CP arranged in the y-direction. The boundary part IM may have substantially the same height as the mold chip patterns CP.

According to embodiments of the inventive concept, the trench region is provided between the mold chip patterns, such that a residual resist generated in an imprint lithography process may be easily exhausted outside the mold substrate. The residual resist does not constitute desired patterns in the imprint lithography process using a resist. Thickness dispersion of the residual resist may occur according to shapes, sizes, and/or positions of the desired patterns, such that it may be difficult to remove the residual resist. If the amount of the residual resist is too much, the residual resist may influence the shapes of the desired patterns. However, the residual resist may be easily exhausted through the trench region in the embodiments of the inventive concept, such that the problems caused by residual resist may be minimized or prevented.

According to embodiments of the inventive concept, the protrusion portions in the trench region may accelerate the exhaust of the residual resist. A surface area of the trench region may increase by the protrusion portions, such that the amount of the residual resist flowing in the trench region may increase by surface tension of the resist. As a result, a residual layer caused by the residual resist may be minimized and it may be prevented that the imprint lithography process is irregularly performed.

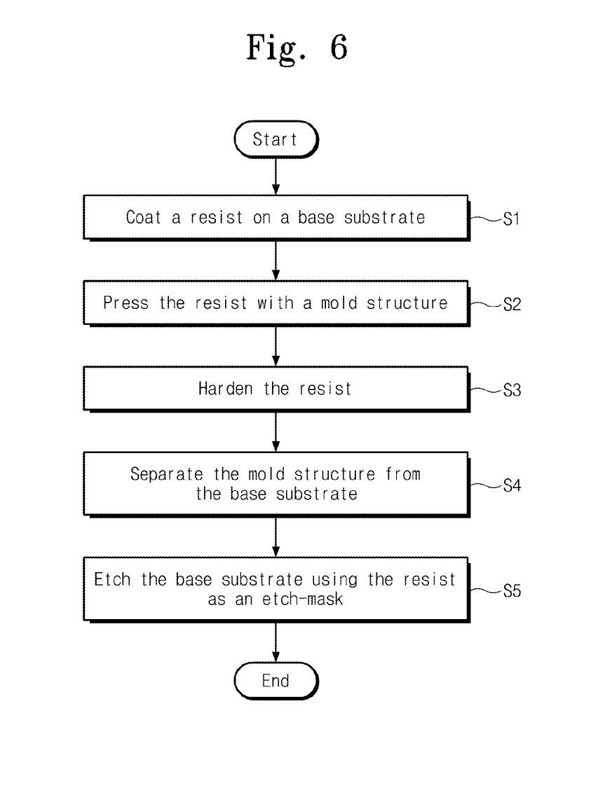

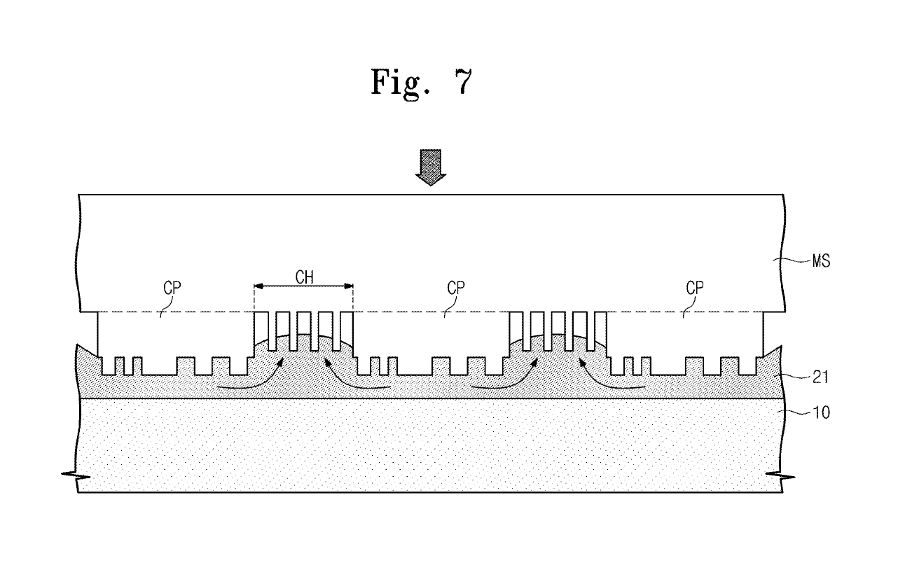

FIG. 6 is a flowchart illustrating a method of imprint lithography using a mold structure according to embodiments of the inventive concept. FIG. 7 is a cross-sectional view illustrating a method of imprint lithography using a mold structure according to embodiments of the inventive concept.

Referring to FIGS. 6 and 7, a resist 21 may be coated on a base substrate 10 (S1). For example, the base substrate 10 may be a semiconductor substrate or an insulating substrate. The resist 21 may be an ultraviolet-curable resin or a thermosetting resin. The resist 21 may be coated by a spin coating method, a droplet dispensing method, or a spraying method.

The resist 21 may be pressed by a mold structure MS (S2). The mold structure MS may include the mold chip patterns CP and the trench region CH between the mold chip patterns CP according to the embodiment illustrated in FIG. 1 or 4. Protrusion portions 110 may be disposed in the trench region CH. A residual resist except the resist 21 filling the concavo-convex parts of the mold chip patterns CP may flow in the trench region CH. Due to the protrusion portions 110, the trench region CH may have a surface area greater than that of another portion of the mold structure MS. Thus, the residual resist may flow in the trench region CH by the surface tension and then may be exhausted.

A hardening process of the resist 21 may be performed (S3). The hardening process may be, for example, a hardening process using an ultraviolet ray. In this case, the mold structure MS and/or the base substrate 10 may be transparent, such that the ultraviolet ray may be irradiated through the mold structure MS and/or the base substrate 10. For example, the mold structure MS may include quartz, glass, or sapphire. In another embodiment, the hardening process may be a thermal hardening process.

The mold structure MS may be separated from the base substrate 10 (S4). In an embodiment, an adhesion preventing agent (not shown) may be provided between the mold structure MS and the resist 21. The adhesion preventing agent may include a self-assembled monomer including fluorine. The adhesion preventing agent may lose an adhesive force at a predetermined temperature or more.

Subsequently, the base substrate 10 is etched using the resist 21 as an etch-mask (S5). As a result, desired fine structures may be transferred to the base substrate 10. Thereafter, the base substrate 10 may be divided into individual chips along a dicing line. The dicing line may be disposed a position corresponding to the trench region CH.

According to embodiments of the inventive concept, the residual resist may be smoothly exhausted when the coated resist is pressed by the mold structure. As a result, the residual layer caused by the residual resist may be minimized, it may be prevented that the imprint lithography process is irregularly performed.

As described above, the residual layer caused by the residual resist may be minimized by the trench region including the protruding structure for exhausting the residual resist, and it may be prevented that the imprint lithography process is irregularly performed by the residual resist.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A mold structure for imprint lithography, the mold structure comprising:
mold chip patterns provided on a mold substrate, the mold chip patterns including patterns for forming nano structures;
a trench region disposed between the mold chip patterns; and
protrusion portions protruding from a bottom surface of the trench region, the protrusion portions extending along the trench region.

2. The mold structure of claim 1, wherein the mold chip patterns are arranged in a first direction and a second direction crossing the first direction on the mold substrate; and
wherein the trench region has a grid-shape extending in the first direction and the second direction.

3. The mold structure of claim 1, wherein the mold chip patterns are arranged in a first direction and a second direction crossing the first direction on the mold substrate; and
wherein the trench region includes a plurality of linear type trenches extending in the first direction.

4. The mold structure of claim 1, wherein a height of a top surface of each of the protrusion portions is lower than a height of a topmost surface of the mold chip patterns.

5. The mold structure of claim 4, the height of the top surface of each of the protrusion portions is substantially equal to or less than a half of the height of the topmost surface of the mold chip patterns.

6. The mold structure of claim 4, wherein the height of the top surface of the each of the protrusion portions is within a range of about 60% to about 90% of the height of a topmost surface of the mold chip patterns.

7. The mold structure of claim 1, wherein the heights of the top surfaces of the protrusion portions are reduced as a distance from the mold chip pattern increases.

8. The mold structure of claim 1, wherein a bottom of a sidewall of the trench region has a rounded surface.

9. The mold structure of claim 1, wherein the mold substrate includes quartz, glass, or sapphire.

10. The mold structure of claim 1, wherein a width of the trench region is less than a width of each of the mold chip patterns.

11. A method of imprint lithography, the method comprising:
coating a resist on a base substrate;
pressing the resist with a mold structure;
hardening the resist; and
separating the mold structure from the base substrate,
wherein the mold structure comprises:
mold chip patterns provided on a mold substrate, the mold chip patterns including patterns for forming nano structures;
a trench region disposed between the mold chip patterns; and
protrusion portions protruding from a bottom surface of the trench region, the protrusion portions extending along the trench region.

12. The method of claim 11, wherein hardening the resist comprises:
irradiating an ultraviolet ray to the resist.

13. The method of claim 11, wherein the resist is coated by a spin coating method, a droplet dispensing method, or a spraying method.

14. The method of claim 11, wherein the mold chip patterns are arranged in a first direction and a second direction crossing the first direction on the mold substrate; and
wherein the trench region has a grid-shape extending in the first direction and the second direction.

15. The method of claim 11, wherein the mold chip patterns are arranged in a first direction and a second direction crossing the first direction on the mold substrate; and
wherein the trench region includes a plurality of linear type trenches extending in the first direction.

16. The method of claim 11, wherein a height of a top surface of each of the protrusion portions is lower than a height of a topmost surface of the mold chip patterns.

17. The method of claim 11, further comprising:
etching the base substrate using the hardened resist as an etch-mask.

18. The method of claim 17, further comprising:
dividing the etched base substrate along a dicing line.

19. The method of claim 18, wherein the trench region has a shape corresponding to the dicing line.
